(19) United States
(12) Patent Application Publication
(10) Pub. No.: US 2024/0337286 A1
(43) Pub. Date: Oct. 10, 2024

(54) INVERTED CONTACT-AIDED ROLLING ELEMENT MECHANISMS AND DEVICES

(71) Applicant: 33 Medical, Inc., Boca Raton, FL (US)

(72) Inventors: Anton Edis BOWDEN, Lindon, UT (US); Daniel James ORR, Spanish Fork, UT (US)

(21) Appl. No.: 18/629,608

(22) Filed: Apr. 8, 2024

Related U.S. Application Data
(60) Provisional application No. 63/457,523, filed on Apr. 6, 2023.

(51) Int. Cl. F16C 11/12

(52) U.S. Cl. CPC F16C 11/12

(57) ABSTRACT

Inverted contact-aided rolling element mechanisms and devices are discussed herein. In various embodiments, the contact-aided compliant mechanism includes a first rigid component, a second rigid component, a first flexible component, a second flexible component, each of the first and second flexible components comprising a first end, a second end, and a third end, and the first and second flexible components disposed between the first and second rigid components.

### CROSS-REFERENCE TO RELATED APPLICATIONS

This application claims priority to U.S. Provisional Patent Application Ser. No. 63/457,523, filed on Apr. 6, 2023, entitled “Compliant Rolling Mechanism with Internal Flexures,” the entire disclosure of which is incorporated herein by reference.

### TECHNICAL FIELD

The present disclosure relates generally to inverted contact-aided rolling element mechanisms and devices.

### BACKGROUND

Compliant mechanisms (CM's) transfer or transform motion, force, or energy via the deformation of flexible members. There are several reasons why compliant mechanisms might be used in place of non-compliant (rigid) mechanisms. Some of these benefits include a reduced part count facilitated by compliant mechanisms, increased precision without the need for separate moving parts with tolerances between them, reduced wear due to the elimination of separate parts rubbing against each other during motion, and the retention of strain energy during deformation, which can often be leveraged to achieve desired functions without requiring separate or additional springs.

Existing compliant mechanisms may have unwelcome axial stiffness, are prone to buckling, and/or cannot be manufactured as a single piece device.

As a result, there is a need for improved single piece compliant mechanisms that are flexible and can be used in various implementations that may consist of flexible geometry that results in optimal rotational strength with tailorable axial stiffness.

### BRIEF SUMMARY OF THE DISCLOSURE

One aspect of the present disclosure generally relates to inverted contact-aided rolling element (ICORE) mechanisms and devices. In particular, the present disclosure relates to inverted contact-aided rolling elements in contact-aided compliant mechanisms and devices comprising compliant and rigid members. Additionally, the present disclosure relates contact-aided rolling element mechanisms and devices comprising interactions between compliant members and rigid members wherein the interactions may include interactions between rigid members that are connected by compliant members, interactions directly between flexible and rigid members, or interactions between flexible segments.

According to a first aspect, a contact-aided compliant mechanism comprising a first rigid component, a second rigid component, a first flexible component, a second flexible component, each of the first and second flexible components comprising a first end, a second end, and a third end, and the first and second flexible components disposed between the first and second rigid components.

According to a second aspect, the contact-aided compliant mechanism of the first aspect, wherein the first, second, and third flexible components comprise a substantially v-shape.

According to a third aspect, the contact-aided compliant mechanism of the first aspect, wherein the first rigid component is positioned parallel to the second rigid component.

According to a fourth aspect, the contact-aided compliant mechanism of the first aspect, wherein the first rigid component is movable in at least one degree of freedom with respect to the second rigid component.

According to a fifth aspect, the contact-aided compliant mechanism of the first aspect, wherein the first rigid component further includes at least one first body contact, wherein the body contact extends from one side of the first rigid component toward the second rigid component, and wherein the at least one first body contact includes a first bearing surface.

According to a sixth aspect, the contact-aided compliant mechanism of the fifth aspect, wherein the second rigid component further includes at least one second body contact, wherein the second body contact extends from one side of the second rigid component toward the first rigid component, and wherein the at least one second body contact includes a second bearing surface.

According to a seventh aspect, the contact-aided compliant mechanism of the sixth aspect, wherein at least one of the first or second bearing surfaces comprises a rounded surface.

According to an eight aspect, the contact-aided compliant mechanism of the first aspect, wherein the first rigid component, second rigid component, first flexible component, and second flexible component are manufactured using 3D printing.

According to a ninth aspect, a contact-aided compliant mechanism comprising a first rigid component, the first rigid component including a first bearing surface, a second rigid component, the second rigid component including an upper and lower bearing surface, a third rigid component, the third rigid component including a third bearing surface, a plurality of flexible components, each of the flexible components including a first end, a second end, and a third end, wherein the first end is attached to one of the first, second, or third rigid component and wherein the third end is attached to one of the first, second, or third rigid component, the first bearing surface selectively engaging the upper bearing surface; and the third bearing surface selectively engaging the lower bearing surface.

According to a tenth aspect, the contact-aided compliant mechanism of the ninth aspect, wherein at least one of the first, upper, lower, or third bearing surfaces has a rounded contour.

According on an eleventh aspect, the contact-aided compliant mechanism of the ninth aspect, wherein the first rigid component further includes at least one first body contact, wherein the body contact extends from one side of the first rigid component toward the second rigid component, and wherein the at least one first body contact includes the first bearing surface.

According to a twelfth aspect, the contact-aided compliant mechanism of the ninth aspect, wherein the second rigid component further includes at least two second body contacts, wherein a first second body contact extends from one side of the second rigid component toward the first rigid component, a second body contact extends from one side of the second rigid component toward the third rigid component, and wherein the first second body contact includes the upper bearing surface and the second body contact includes the lower bearing surface.

According to a thirteenth aspect, the contact-aided compliant mechanism of the ninth aspect, wherein the third rigid component further includes at least one third body contact, wherein the third body contact extends from one side of the third rigid component toward the second rigid component, and wherein the at least one third body contact includes the third bearing surface.

According to a fourteenth aspect, the contact aided compliant mechanism of the ninth aspect, wherein each of the flexible components further includes a first region disposed between the first end and the second end and a second region disposed between the second end and the third end.

According to a fifteenth aspect, the contact-aided compliant mechanism of the fourteenth aspect, wherein the first region includes a first radius of curvature.

According to a sixteenth aspect, the contact-aided compliant mechanism of the fourteenth claim, wherein the second region includes a second radius of curvature.

According to a seventeenth aspect, the contact-aided compliant mechanism of the ninth aspect, wherein each of the first and second regions comprise a Euler spiral.

### BRIEF DESCRIPTION OF THE DRAWINGS

FIG. 1 is a perspective view of an exemplary CORE mechanism, according to one embodiment.

FIG. 2 is a perspective view of an exemplary CORE mechanism, according to another embodiment.

FIG. 3 is a perspective view of an exemplary CAFP mechanism, according to one embodiment.

FIG. 4 is a perspective view of an exemplary CAFP mechanism, according to another embodiment.

FIG. 5 is a side view of the CAFP mechanism of FIG. 4.

FIG. 6 is a perspective view of an exemplary ICORE mechanism, according to one embodiment.

FIG. 7 is a perspective view of an exemplary ICORE mechanism, according to an embodiment.

FIG. 8 is a perspective view of an exemplary ICORE mechanism, according to one embodiment.

FIG. 9 is a perspective view of an exemplary ICORE mechanism, according to an embodiment.

FIG. 10 is a perspective view of another exemplary ICORE mechanism, according to an embodiment.

FIG. 11 is an exploded view of the ICORE mechanism of FIG. 10.

FIG. 12 is an A-line illustration of the pseudo rigid body model of the mechanism stack used in various embodiments of the ICORE mechanism.

FIG. 13 is an illustration of a system of the pseudo rigid body model of the mechanism stack used in various embodiments of the ICORE mechanism.

FIG. 14 is an illustration of the moving center of various embodiments of the ICORE mechanism at an initial position.

FIG. 15. is an illustration of the moving center of various embodiments of the ICORE mechanism at a final rotated position.

FIG. 16 is an illustration of a free body diagram of interacting rigid bodies during compression.

FIG. 17 is an illustration of a free body diagram of interacting rigid bodies during rotation.

FIG. 18 illustrates the compressive stiffness of an exemplary mechanism, according to various embodiments.

FIG. 19 illustrates the rotational stiffness of an exemplary mechanism, according to various embodiments.

### DETAILED DESCRIPTION

Whether or not a term is capitalized is not considered definitive or limiting the meaning of a term. As used in this document, a capitalized term shall have the same meaning as an uncapitalized term is intended. However, the capitalization or lack thereof within the remainder of this document is not intended to be necessarily limiting unless the context clearly indicates that such limitation is intended.

Before any embodiments are described in detail, it is to be understood that the disclosure is not limited in its application to the details of construction and the arrangement of components set forth in the following description or illustrated in the following drawings, which is limited only by the claims that follow the present disclosure. The disclosure is capable of other embodiments, and of being practiced, or of being carried out, in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following description is presented to enable a person skilled in the art to make and use embodiments of the disclosure. Various modifications to the illustrated embodiments will be readily apparent to those skilled in the art, and the generic principles herein may be applied to other embodiments and applications without departing from embodiments of the disclosure. Thus, embodiments of the disclosure are not intended to be limited to embodiments shown but are to be accorded the widest scope consistent with the principles and features disclosed herein. The following detailed description is to be read with reference to the figures, in which like elements in different figures have like reference numerals. Skilled artisans will recognize the examples provided herein have many useful alternatives and fall within the scope of embodiments of the disclosure.

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Contact-aided compliant mechanisms (CCMs) are compliant mechanisms that include contact interactions between flexible members and rigid members. These interactions can occur in a variety of ways with interactions between rigid members that are connected by flexible members, interactions directly between flexible and rigid members, interactions between flexible segments, or any other suitable configuration.

According to some embodiments, the mechanisms and devices herein are directed to inverted contact-aided rolling element (ICORE) mechanisms and devices. The described ICORE mechanisms and devices are an improvement over contact-rolling element (CORE) mechanisms and devices and cross-axis flexural pivot (CAFP) mechanisms and devices.

The CORE mechanism relies on rolling contact of rigid bodies over flexible members, artificially constraining them due to compressive forces in the central body of the mechanism. The various embodiments of the ICORE mechanism includes rolling features at the lateral edges of opposing rigid bodies, with flexible members placed between the rigid bodies. This configuration allows for tailorable curvature of the rolling features, and mechanical stiffness defined by the mechanical properties of the material and the dimensions of the connecting flexible members. In some embodiments, the ICORE mechanism is designed to avoid pinching the flexible members between the rolling contact surfaces. The ICORE mechanism may also be designed to allow the flexible members to behave as compliant springs, which can support loading of the rigid bodies prior to contact between the rolling contact surfaces. This can further allow for yielding capability for the ICORE mechanism to provide tailored force-displacement stiffness response along a vertical axis and a tailored applied moment-rotation stiffness around a horizontal axis. In some embodiments, the ICORE mechanism may provide force-displacement stiffness along any suitable axis without departing from the principles of this disclosure.

In some embodiments, the ICORE mechanism incorporates a bilinear compressive stiffness response with an initial tailorable stiffness governed by the flexural geometry, followed by a stiffness curve governed by the material stiffness at the contact point. In some embodiments, the ICORE mechanism can achieve 1 or 2 degrees of rotational freedom as well as 1 degree of translational freedom. In some embodiments, the ICORE mechanism may have more or fewer degrees of rotational and translational freedom without departing from the principles of this disclosure.

Unlike the CORE mechanism and contact aided CAFP, the ICORE mechanism may be manufactured with some initial spacing between the interacting rigid bodies. Put another way, the ICORE mechanism may be manufactured so that when the mechanism is unloaded, there is a gap between the rolling features. This initial spacing may allow for a lower compressive stiffness prior to contact. Additionally, this initial spacing may be beneficial for manufacturability of the device using additive manufacturing (e.g., 3D printing). In some cases, during additive manufacturing, if there is initial contact it may lead to the fusion of the rigid bodies. Manufacturing of the ICORE mechanism with an initial gap, however, may allow the entire ICORE mechanism to be manufactured without the need for subsequent assembly or machining.

Another benefit of the ICORE mechanism is the potential for reduced stress in the flexible members. The CORE mechanism may be able to withstand high compressive loads, but these loads are transferred through the flexible members, which are compressed between the rigid bodies, which may increase the stress on the mechanism or device. The ICORE mechanism may maintain the ability to support high compressive loads, but does not transmit these forces through the compliant mechanisms, thereby eliminating this potential challenge.

Additionally, in some embodiments, the ICORE mechanism may be used in any device. In yet another embodiment, the ICORE mechanism may be used in a device that is a spinal implant.

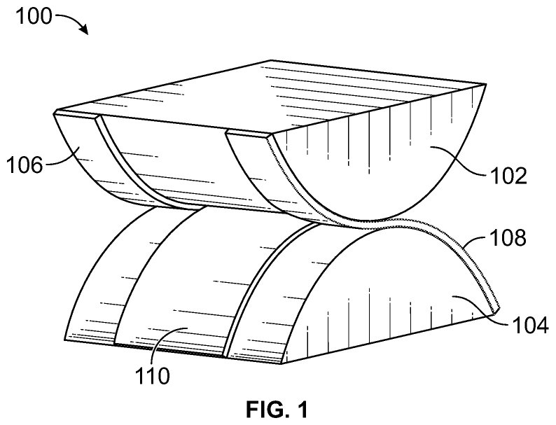

Turning now to FIG. 1, one embodiment of a contact aided rolling element (CORE) mechanism 100 is shown. As shown, CORE mechanism 100 may include two rigid bodies 102, 104 that interact in a rolling motion with flexible components 106, 108, 110 between them. Specifically, CORE mechanism 100 includes a first rigid body 102, a second rigid body 104, a first flexible component 106, a second flexible component 108, and a third flexible component 110. In some embodiments, the CORE mechanism 100 is designed with only a single degree of freedom, meaning it can rotate around a single axis.

In multiple embodiments, the interaction of the first and second rigid bodies 102, 104 allows the mechanism 100 to bear compressive loads while maintaining the ability to rotate about a mobile center of rotation and generate little to no wear.

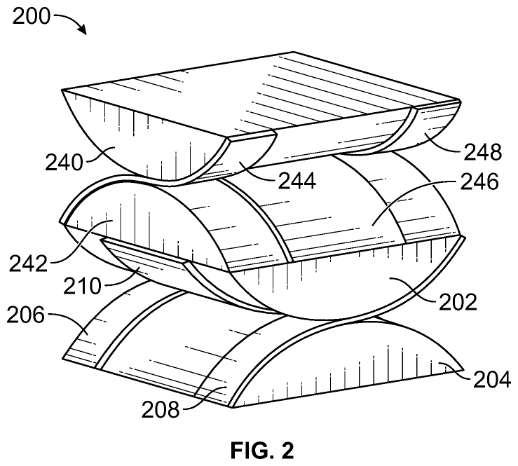

Turning to FIG. 2, an additional embodiment of CORE mechanism 200 in accordance with the principles of this disclosure is shown. CORE mechanism 200 comprises essentially two of CORE mechanisms 100 stacked on top of each other and positioned perpendicular to one another. In various embodiments, the CORE mechanism 200 includes a first rigid body 202, a second rigid body 204, a first flexible member 206, a second flexible member 208, and a third flexible member 210, a third rigid body 240, a fourth rigid body 242, a fourth flexible member 244, a fifth flexible member, and a sixth flexible member 246. In some embodiments, the CORE mechanism 200 is designed with at least two degrees of freedom and a rotation around at least two axes.

In some embodiments, the CORE mechanism 200 comprises at least 2 stacked mechanisms 100 with at least the third and fourth rigid bodies 240, 242 are rotated 90 degrees relative to the first and second bodies 202, 204. In some embodiments, this configuration of the CORE mechanism 200 may maintain the compressive load bearing capability while adding the ability to rotate about two axes with some tailorable rotational stiffness. In various embodiments, the CORE mechanism 100, 200 is described as in U.S. Pat. No. 8,308,801 and WO2016/123139 which are incorporated in their entirety.

Disadvantages of the CORE mechanism 100 and 200 include compressive stiffness prior to contact, inability to manufacture using additive manufacturing or 3D printing, and it requires additional assembly. Additionally, the CORE mechanism 100 and 200 can withstand high compressive loads, but these loads are transferred through the flexible components (e.g. 104, 106, 110, 206, 208, 210, 244, 246, and 248) which may increase the stress on the mechanism 100, 200.

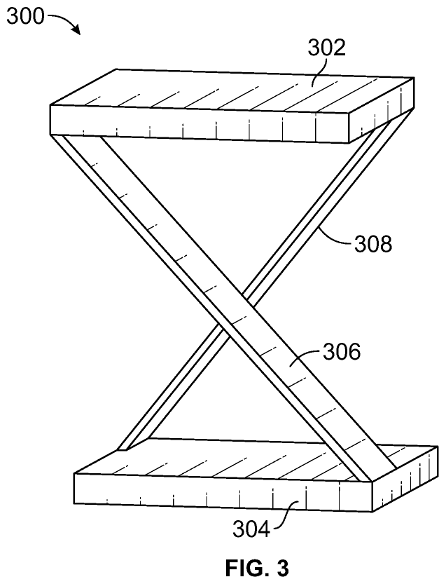

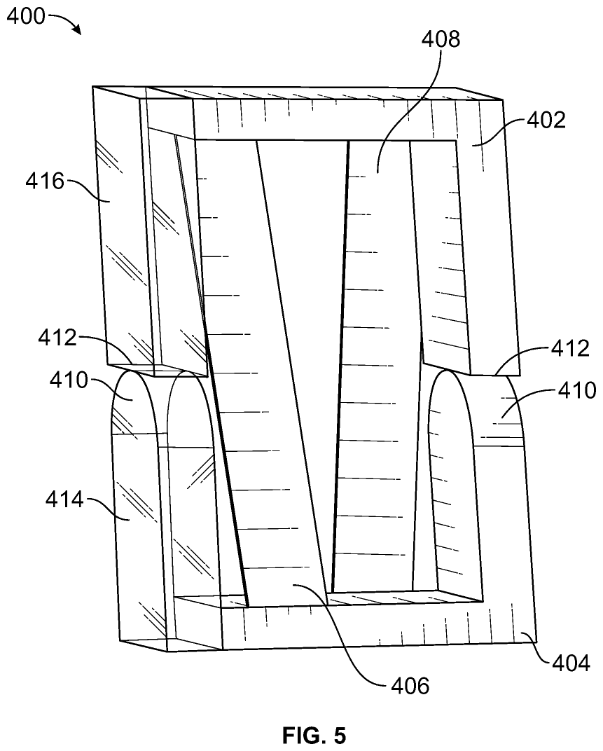

Referring now to FIGS. 3-5, an exemplary cross axis flexural pivot (CAFP) mechanism 300, 400 is shown. In various embodiments, the CAFP mechanism 300, 400 is a mechanism designed to rotate about a single axis. In additional embodiments, the mechanism 300, 400 is a cross-axis flexural pivot. As shown in FIG. 3, the CAFP mechanism 300 includes a first base 302, a second base 304, a first flexible member 306 and a second flexible member 308.

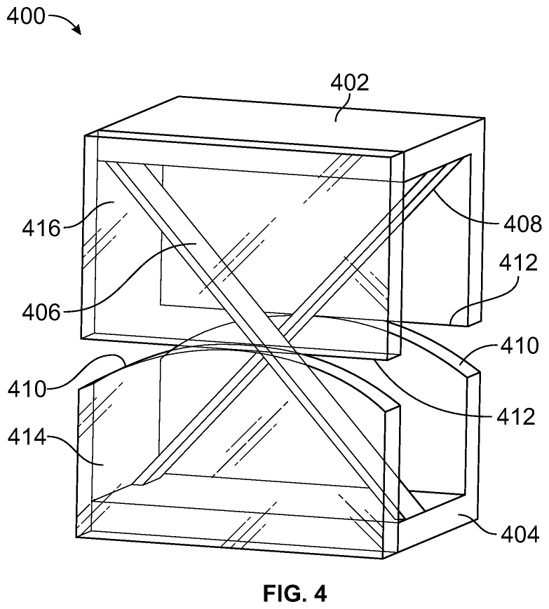

As shown in FIG. 4, the CAFP mechanism 400 may additionally include a first base 402, a second base 404, a first flexible member 406, a second flexible member 408, a first component 416, and a second component 414. In some embodiments, first base 402 may include a first bearing surface 412 for contact with a second bearing surface 410 of second base 404. Additionally, in some embodiments, the first component 416 has a similar shape to the side of the first base 402. In another instance, the second component 414 has a similar shape to the side of the second base 404. This configuration can allow for rolling movement along a single axis. Of course, first component 416 and second component 414 may have any suitable shape without departing from the principles of this disclosure.

In some embodiments, the CAFP mechanism 300, 400 may be prone to buckling if the mechanism 300, 400 experiences a compressive load.

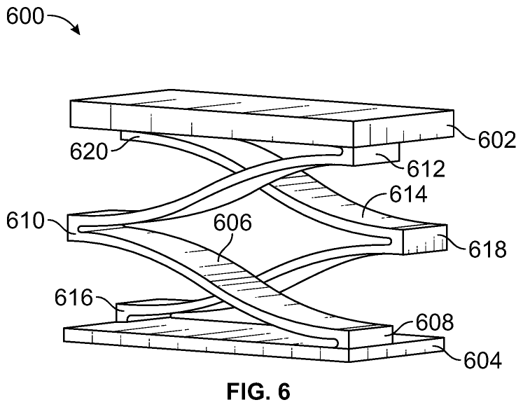

Turning now to FIGS. 6-11, various embodiments of an inverse contact-aided rolling element (ICORE) mechanism is shown. As described herein, the ICORE mechanism is a contact-aided compliant mechanism that integrates elements of the CORE mechanism and the CAFP mechanism, and pre-curved flexible beams. The ICORE mechanism and devices thereof address the shortcomings of the CORE and CAFP mechanisms and provide additional improvements.

Turning now to FIG. 6, one embodiment of an ICORE mechanism 600 is provided. The ICORE mechanism 600 includes a first rigid component 602, a second rigid component 604, a first flexible component 606, and a second flexible component 614. In multiple embodiments, the ICORE mechanism 600 may have at least 1 or 2 degrees of rotational freedom. Unlike the CORE and CAFP mechanisms described above, the ICORE mechanism 600 may include initial spacing in between the rigid components 602, 604.

The first flexible component 606 may include a first end 608, a second end 610, and a third end 612. In some embodiments, the first flexible component 606 may comprise any suitable shape without departing from the principles of this disclosure. In various embodiments, the first flexible component 606 is in a substantially v-shape comprising the first end 608, the second end 610, and the third end 612 wherein the second end 610 is the point of the substantially v-shape. In some embodiments, the shape of the region between the first end 608 and the second end 610, as well as the shape of the region between the second end 610 and the third end 612 of the first flexible component 606 can have a curvature with a radius of curvature of at least 20 mm, at least 30 mm, at least 60 mm, at least 70 mm. In certain embodiments, the curvature radii between the first end 608 and the second end 610 are the same as the curvature radii between the second end 610 and the third end 612. In some embodiments, the curvature radii between the first, second and third ends 608, 610, and 612 may have any suitable radius without departing from the principles of this disclosure. In alternative embodiments, the shape of the region between the first end 608 and the second end 610, as well as the shape of the region between the second end 610 and the third end 612 of the first flexible member 606 can be substantially straight.

In some embodiments, the shape of the region between the first end 608 and the second end 610, as well as the shape of the region between the second end 610 and the third end 612 of the first flexible component 606 may be designed to be configured as a Euler spiral. In some embodiments, the shape of the region between the first end 608 and the second end 610, as well as the shape of the region between the second end 610 and the third end 612 of the first flexible component 606 may be designed to be configured as a deployable Euler spiral connector (DESC), which provides maximum compressibility for packing purposes. See U.S Patent Publication 2022/0047397 incorporated by reference in its entirety.

In various embodiments, the first flexible component 606 has a thickness of at least 0.5 mm, 1 mm, 1.5 mm, 2 mm, or 5 mm.

In various embodiments, the first flexible component 606 has a width of at least 5 mm, at least 7 mm, at least 14 mm, at least 20 mm.

The second flexible component 614 may include a first end 616, a second end 618, and a third end 620. In some cases, the second flexible component 614 may be in any shape without departing from the principles of this disclosure. In some embodiments, the second flexible component 614 is in a substantially V-shape comprising the first end 616, the second end 618, and the third end 620 wherein the second end 618 is the point of the v-shape. In some embodiments, the shape of the region between the first end 616 and the second end 618, as well as the shape of the region between the second end 618 and the third end 620 of the second flexible component 614 can have a curvature with a radius of curvature of at least 20 mm, at least 30 mm, at least 60 mm, at least 70 mm. In certain embodiments, the curvature radii between the first end 616 and the second end 618 are the same as the curvature radii between the second end 618 and the third end 620. In some embodiments, the curvature radii between the first, second and third ends 616, 618, 620 may have any suitable radius without departing from the principles of this disclosure. In alternative embodiments, the shape of the region between the first end 608 and the second end 610, as well as the shape of the region between the second end 610 and the third end 612 of the first flexible member 606 can be substantially straight.

In some embodiments, the shape of the region between the first end 616 and the second end 618, as well as the shape of the region between the second end 618 and the third end 620 of the second flexible component 614 may be designed to be configured as a Euler spiral. In yet other embodiments, the shape of the region between the first end 616 and the second end 618, as well as the shape of the region between the second end 618 and the third end 620 of the second flexible component 614 may be designed to be configured as a deployable Euler spiral connector (DESC), which provides maximum compressibility for packing purposes. See U.S Patent Publication 2022/0047397 incorporated by reference in its entirety.

In some embodiments, the second flexible component 614 has a thickness of at least 0.5 mm, 1 mm, 1.5 mm, 2 mm, or 5 mm.

In some embodiments, the second flexible component 614 has a width of at least 5 mm, at least 7 mm, at least 14 mm, at least 20 mm.

In other embodiments, the first flexible component 606 and the second flexible component 614 can be positioned parallel to each other. In yet another instance, the first flexible component 606 and the second flexible component 614 can be positioned in an INV-CORE configuration. In some embodiments of mechanism 600, the INV-CORE configuration is a configuration where the second end 610 of the first flexible component 606 and the second end 618 of the second flexible component 614 are positioned at opposing sides of the ICORE mechanism 600. In various embodiments, the INV-CORE configuration may include a mechanism with multiple traversal flexible components.

In alternative embodiments, the first flexible component 606 and the second flexible component 614 can be positioned in an INT-CORE configuration. In some embodiments of mechanism 600, the INT-CORE configuration is a configuration where the second end 610 of the first flexible component 606 and the second end 618 of the second flexible component 614 are both positioned in the center of the mechanism body and the first end 608 and third end 612 of the first flexible component 606 and the first end 616 and third end 620 of the second flexible 614 component are at opposing sides of the mechanism 600, i.e., the first and second flexible components 606, 614 traverse approximately half of the length of the mechanism body. In various embodiments, the INT-CORE configuration may include a mechanism with multiple half-traversal flexible components.

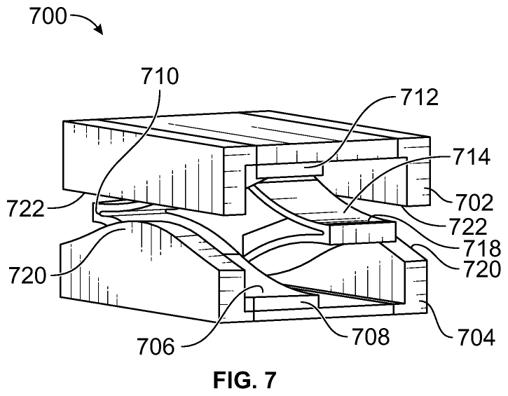

Turning to FIG. 7, another embodiment of an ICORE 700 mechanism is shown. The ICORE mechanism 700 of FIG. 7 can have the same types of system components as the mechanism 600 of FIG. 6 (wherein similar components have like reference numbers) but can have more system components and/or system components in a different configuration than the mechanism 600 of FIG. 6.

In the embodiment shown, the ICORE mechanism 700 includes a first rigid component 702, a second rigid component 704, a first flexible component 706, and a second flexible component 714. In some embodiments, the ICORE mechanism 700 may have at least 1 or 2 degrees of rotational freedom. Unlike the CORE and CAFP mechanisms, the ICORE mechanism 700 may be designed to include initial spacing in between the interacting rigid components 702 and 704.

The first flexible component 706 may include a first end 708, a second end 710, and a third end 712. In some cases, the first flexible component 706 may be in any shape. In various embodiments, the first flexible component 706 is in a v-shape comprising the first end 708, the second end 710, and the third end 712 wherein the second end 710 is the point of the v-shape. In some embodiments, the shape of the region between the first end 708 and the second end 710, as well as the shape of the region between the second end 710 and the third end 712 of the first flexible component 706 can have a curvature with a radius of curvature of at least 20 mm, at least 30 mm, at least 60 mm, at least 70 mm.

The second flexible component 714 may include a first end (not shown), a second end 718, and a third end (not shown). In some cases, the second flexible component 714 may be in any shape. In various embodiments, the second flexible component 714 is in a substantially V-shape comprising the first end, the second end 718, and the third end wherein the second end 718 is the point of the V-shape. In some embodiments, the shape of the region between the first end and the second end 718, as well as the shape of the region between the second end 718 and the third end of the second flexible member 714 can have a curvature with a radius of curvature of at least 20 mm, at least 30 mm, at least 60 mm, at least 70 mm.

In multiple embodiments, the first flexible component 706 and/or second flexible component 714 may be V-shaped wherein the V-shape includes a curvature. In another embodiment, the V-shape may be substantially straight.

In one embodiment, the ICORE mechanism 700 may include at least the first rigid component 702 and/or the second rigid component 702 designed to include at least one rounded body contact. In some embodiments, the first rigid component 702 may be designed in any shape. In another embodiment, the first rigid component 702 may be designed to include at least two edges with a bearing surface 722 on opposite sides of the first rigid component 702 for contact with the second rigid component 704. In various embodiments, the second rigid component 704 may be designed in any shape. In another embodiment, the second rigid component 704 may be designed to include at least two edges with a rounded end 720 on opposite sides of the second rigid component 704 for contact with the first rigid component 702.

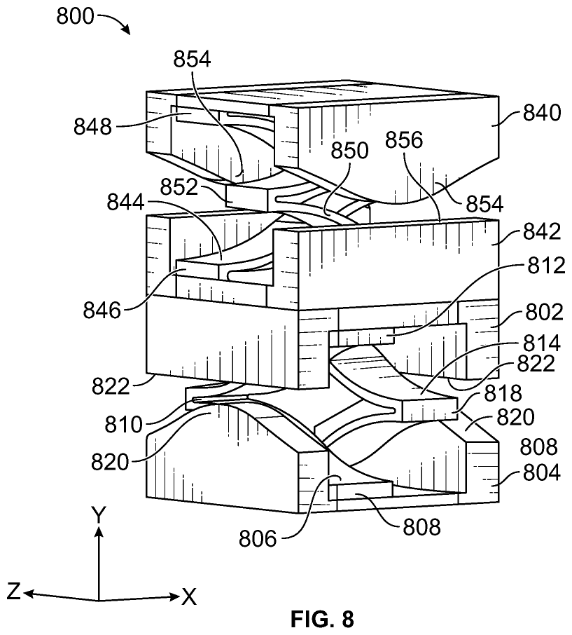

Turning to FIG. 8, yet another embodiment of an ICORE 800 mechanism in accordance with the principles of this disclosure is shown. The ICORE mechanism 800 of FIG. 8 can have the same types of system components as the ICORE mechanism 600 and 700 of FIGS. 6 and 7 (wherein similar components have like reference numbers) but can have more system components and/or system components in a different configuration than the mechanism 600 and 700 of FIGS. 6 and 7. In various embodiments, the ICORE mechanism 800 may have either 1 or 2 degrees of rotational freedom at some tailorable stiffness, while introducing a 3rd degree of translational freedom in vertical compression with a bilinear tailorable compressive stiffness. In some embodiments, the mechanism 800 may compress along the y axis and rotate along the x and z axes. In some other embodiments, the mechanism 800 may be designed to compress along any suitable axis and rotate along any other suitable axis without departing from the principles of this disclosure.

In multiple embodiments, the ICORE mechanism can be either a single level mechanism as exemplified in FIG. 7 or in some embodiments, a double level mechanism as exemplified in FIG. 8. In one embodiment, the ICORE mechanism 800 as described in FIG. 8 can be achieved by stacking at least two ICORE mechanisms 700 as described in FIG. 7.

The ICORE mechanism 800 includes a first rigid component 802, a second rigid component 804, a first flexible component 806 (having a first end 808, a second end 810, and a third end 812), and a second flexible component 814 (having a first end (not shown), a second end 818, and a third end (not shown)).

In some embodiments, the first rigid component 802 may be designed in any shape. In another embodiment, the first rigid component 802 may be designed to include at least two edges with a bearing surface 822 on opposite sides of the first rigid component 802 for contact with the second rigid component 804.

In various embodiments, the second rigid component 804 may be designed in any shape. In another embodiment, the second rigid component 804 may be designed to include at least two edges with rounded body contact 820 on opposite sides of the second rigid component 804 for contact with the first rigid component 802.

The ICORE mechanism 800 may additionally include a third rigid component 840, a fourth rigid component 842, a third flexible component 844 and a fourth flexible component 850.

Unlike the CORE and CAFP mechanisms, the ICORE mechanism 800 may be designed to include initial spacing in between the interacting rigid components 802 and 804 and between 840 and 842. In various embodiments of mechanism 800, the orientation of the third rigid component 840, the fourth rigid component 842, the third flexible component 844, and the fourth flexible component 850 may be perpendicular to the orientation to the first rigid component 802, the second rigid component 804, the first flexible component 806, and the second flexible component 814.

In other embodiments of the ICORE mechanism 800, the orientation of the third rigid component 840, the fourth rigid component 842, the third flexible component 844, and the fourth flexible component 850 may be in any configuration besides perpendicular to the orientation to the first rigid component 802, the second rigid component 804, the first flexible component 806, and the second flexible component 814. In some instances, a non-perpendicular configuration of the components may allow for the mechanism to avoid movement in a particular region of space, creating a region of avoidance. In various embodiments, the third rigid component 840 may be designed in any suitable shape without departing from the principles of this disclosure. In another embodiment, the third rigid component 840 may be designed to include at least two edges with a rounded body contact 854 on opposite sides of the second rigid component 840 for contact with the fourth rigid component 842.

In some embodiments, the fourth rigid component 842 may be designed in any suitable shape without departing from the principles of this disclosure. In another embodiment, the fourth rigid component 842 may be designed to include at least two edges with a bearing surface 856 on opposite sides of the fourth rigid component 842 for contact with the third rigid component 840. Additionally, in other embodiments, the first flexible component 806 and the second flexible component 814 can be positioned parallel to each other. In yet another instance, the first flexible component 806 and the second flexible component 814 can be positioned in an INV-CORE configuration. In some embodiments of mechanism 800, the INV-CORE configuration is a configuration where the second end 810 of the first flexible component 806 and the second end 818 of the second flexible component 814 are at opposing sides of the mechanism 800.

In some embodiments, the first flexible component 806 and the second flexible component 814 can be positioned in an INT-CORE configuration. In some embodiments of mechanism 800, the INT-CORE configuration is a configuration where the second end 810 of the first flexible component 806 and the second end 818 of the second flexible component 814 are both positioned in the center of the mechanism body and the first 808 and third ends 812 of the first flexible member 806 and the first and third ends of the second flexible component 814 are at opposing sides of the mechanism 800.

In various embodiments, the third flexible component 844 and the fourth flexible component 850 can be positioned parallel to each other. In yet another instance, the third flexible component 844 and the fourth flexible component 850 can be positioned in an INV-CORE configuration. In some embodiments of mechanism 800, the INV-CORE configuration is a configuration where the second end (not shown) of the third flexible component 844 and the second end 852 of the fourth flexible component 850 are at opposing sides of the mechanism 800.

In alternative embodiments, the third flexible component 844 and the fourth flexible component 850 can be positioned in an INT-CORE configuration. In some embodiments of mechanism 800, the INT-CORE configuration is a configuration where the second end (not shown) of the third flexible component 844 and the second end 852 of the fourth flexible component 850 are both positioned in the center of the mechanism body and the first and third ends 846, 848 of the third flexible component 844 and the first and third ends (not shown) of the fourth flexible component 850 are at opposing sides of the mechanism 800.

In various embodiments, the mechanism 800 may include a first and second flexible component 806, 814 designed in an INV-CORE configuration and a third and fourth flexible component 844, 850 designed in an INV-CORE configuration. In alternative embodiments, the mechanism 800 may include a first and second flexible component 806, 814 designed in an INT-CORE configuration and a third and fourth flexible component 844, 850 designed in INT-CORE configuration. In other embodiments, the mechanism 800 may include a first and second flexible component 806, 814 designed in an INV-CORE configuration and a third and fourth flexible component 844, 850 designed in an INT-CORE configuration. In alternative embodiments, the mechanism 800 may include a first and second flexible component 806, 814 designed in an INT-CORE configuration and a third and fourth flexible component 844, 850 designed in an INV-CORE configuration.

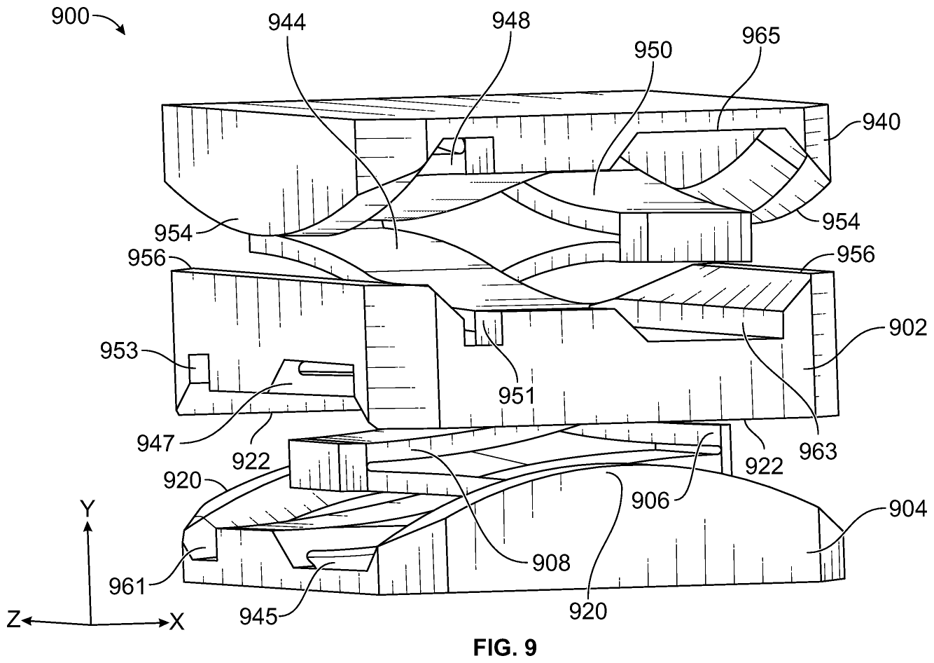

Referring to FIG. 9, an exemplary embodiment of an ICORE 900 mechanism is provided. The ICORE mechanism 900 of FIG. 9 can have the same types of system components as the mechanism 600, 700, and 800 of FIGS. 6-8 (wherein similar components have like reference numbers) but can have less system components and/or system components in a different configuration than the mechanism 600 700, and 800 of FIGS. 6-8. Additionally, the mechanism 900 can have more system components and/or system components in a different configuration than the mechanism 600 700, and 800 of FIGS. 6-8. In various embodiments, the ICORE mechanism 900 may have either 1 or 2 degrees of rotational freedom at some tailorable stiffness, while introducing a 3rd degree of translational freedom in vertical compression with a bilinear tailorable compressive stiffness. The mechanism 900 may compress along the y axis and rotate along the x and z axes.

In multiple embodiments, the ICORE mechanism 900 includes a first rigid component 902, a second rigid component 904, a third rigid component 940, a first flexible component 906, a second flexible component 914, a third flexible component 944, and a fourth flexible component 950.

Similar to the ICORE mechanism 800 of FIG. 8, the ICORE mechanism 900 of FIG. 9 may include a first rigid component 902 with at least two lower edges with bearing surfaces 922 for contact with the second rigid component 904 which can be designed with at least two edges with rounded body contact 920 for contact with the first rigid component 902. In some embodiments, the first rigid component 902 may additionally have at least two upper edges with a bearing surface 956 for contact with the third rigid component 940. In some embodiments, the third rigid component 940 has at least two edges with a rounded body contact 954 for contact with the first rigid component 902.

In various embodiments, the ICORE mechanism 900 can include the rigid components 902, 904, 940 designed to include at least one or several features which are formed to mate around the flexible components 906, 914, 944, 950. In some embodiments, the mechanism 900 may include a first feature 945, a second feature 947, a third feature 965, and a fourth feature 963. In multiple embodiments, the features can be any shape that allows for the flexible components to fit therewithin.

Additionally, in yet another embodiment, the mechanism 900 can include the rigid components 902, 904, 940 designed to include at least one or several indented regions. In some embodiments, the mechanism 900 may include a first indented region 949, a second indented region 951, a third indented region 953, and a fourth indented region 961. In multiple embodiments, the indented regions can be any shape. In some embodiments, the indented regions may be designed as rounded, square, and/or rectangular shapes.

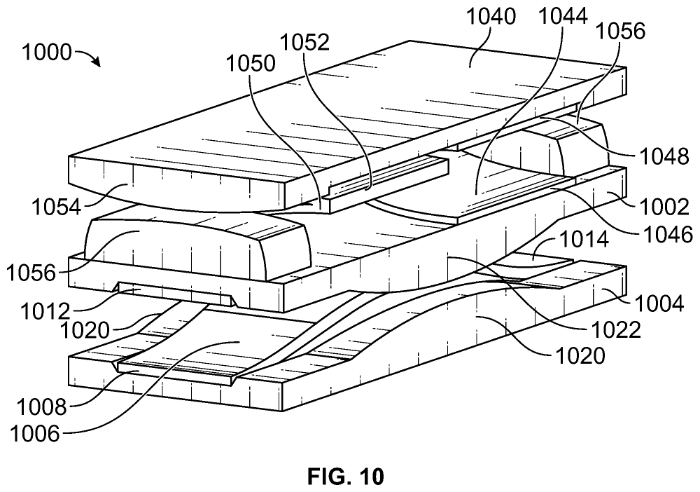

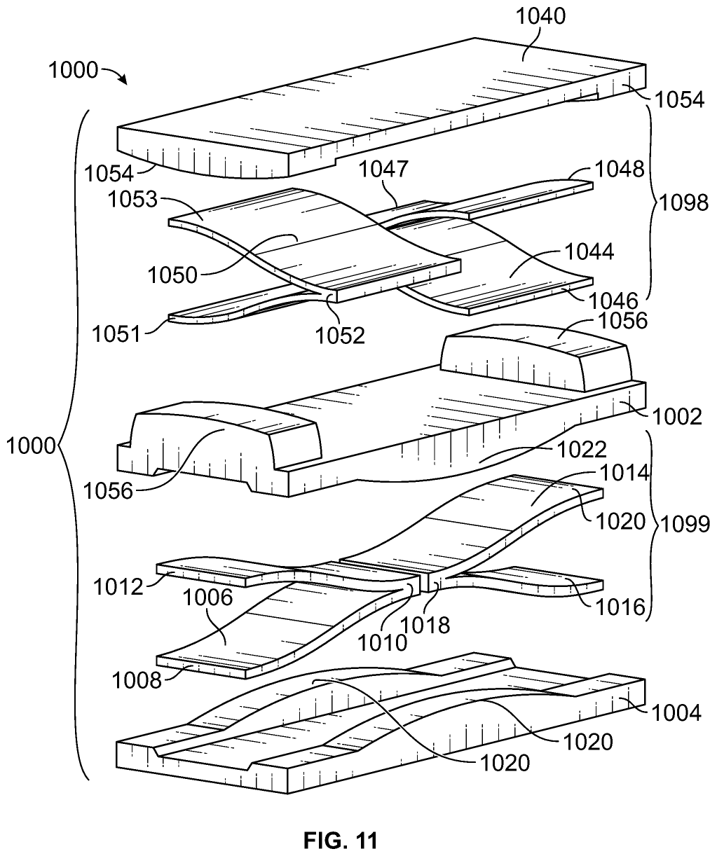

Referring now to FIGS. 10-11, yet another embodiment of an ICORE 1000 mechanism is provided. In some embodiments, the mechanism 1000 can be configured into any device. In additional embodiments, the mechanism 1000 can be designed as a medical implant. The ICORE mechanism 1000 of FIG. 10 can have the same types of system components as the mechanism 600, 700, 800, and 900 of FIGS. 6-9 (wherein similar components have like reference numbers) but can have less system components and/or system components in a different configuration than the mechanism 600 700, 800, and 900 of FIGS. 6-9. Additionally, the mechanism 1000 can have more system components and/or system components in a different configuration than the mechanism 600 700, 800, and 900 of FIGS. 6-9. In various embodiments, the ICORE mechanism 1000 may have either 1 or 2 degrees of rotational freedom at some tailorable stiffness, while introducing a 3rd degree of translational freedom in vertical compression with a bilinear tailorable compressive stiffness.

In various embodiments, the mechanism 1000 includes a first rigid component 1002, a second rigid component 1004, a third rigid component 1040, a lower portion 1099 including a first flexible component 1006, a second flexible component 1014, an upper portion 1098 including a third flexible component 1044, and a fourth flexible component 1050.

The first rigid component 1002 can include at least one lower bearing surface 2022 for contact with the second rigid component 1004. In some embodiments, the first rigid component 1002 can include at least one or two upper bearing surfaces for contact with the third rigid component 1040. In some embodiments, the second rigid component 1004 can comprise at least one or two upper bearing surfaces 1020 for contact with the first rigid component 1002. In another embodiment, the third rigid component 1040 includes at least one or two lower bearing surfaces 1054 for contact with the first rigid component 1002.

In multiple embodiments of ICORE mechanism 1000, the first rigid component 1002 can be designed as a middle rigid body comprising at least two rounded bearing surface 1056 which can control z axis rotation. In additional embodiments, the first rigid component 1002 can also include at least one second rounded body contact 1022 which can control x axis rotation. In some embodiments, the second rigid component 1004 can be designed as a lowermost rigid body with at least one or two rounded bearing surface 1020 which can control the rotation about the x axis. In additional embodiments, the third rigid component 1040 can be designed as an uppermost rigid body with at least one or two rounded bearing surface 1054 which can control rotation about the z axis.

In some embodiments, the first flexible component 1006 can include a first end 1008, a second end 1010, and a third end 1012. In another embodiment, the second flexible component 1014 can include a first end 1016, a second end 1018, and a third end 1097. In various embodiments, the third flexible component 1044 can include a first end 1046, a second end 1047, and a third end 1048. In yet another embodiment, the fourth flexible component 1050 can include a first end 1051, a second end 1052, and a third end 1053.

In some embodiments, the flexible components 1006, 1014, 1044, 1050 can be designed in any shape. In another embodiment, the flexible components 1006, 1014, 1044, 1050 can be designed in a v-shape comprising the first end 1008, 1016, 1046, 1051, the second end 1010, 1018, 1047, 1052, and the third end 1012, 1097, 1048, 1053, wherein the second end 1010, 1018, 1047, 1052 is the point of the v-shape. In other embodiments, the shape of the region between the first end 1008, 1016, 1046, 1051 and the second end 1010, 1018, 1047, 1052, as well as the shape of the region between the second end 1010, 1018, 1047, 1052 and the third end 1012, 1097, 1048, 1053 of the flexible components 1006, 1014, 1044, 1050 can have a curvature with a radius of curvature of at least 20 mm, at least 30 mm, at least 60 mm, at least 70 mm.

In additional embodiments, the shape of the region between the first end 1008, 1016, 1046, 1051 and the second end 1010, 1018, 1047, 1052, as well as the shape of the region between the second end 1010, 1018, 1047, 1052 and the third end 1012, 1097, 1048, 1053 of the flexible components 1006, 1014, 1044, 1050 may be configured as a Euler spiral. In yet other embodiments, the shape of the region between the first end 1008, 1016, 1046, 1051 and the second end, 1010, 1018, 1047, 1052, as well as the shape of the region between the second end 1010, 1018, 1047, 1052 and the third end 1012, 1097, 1048, 1053 of the flexible components 1006, 1014, 1044, 1050 may be configured as a deployable Euler spiral connector (DESC), which provides maximum compressibility for packing purposes. See U.S Patent Publication 2022/0047397 incorporated by reference in its entirety

In multiple embodiments, the flexible components 1006, 1014, 1044, 1050 may be V-shaped wherein the V-shape includes a curvature. In another embodiment, the V-shape may be substantially straight.

As shown in FIG. 11, in another embodiment, to achieve at least 2 degrees of rotational freedom and a 3^{rd} degree of translational freedom, the mechanism 1000 can include an upper portion 1098 of at least two flexible components configured in an INV-CORE configuration (as described in FIG. 6) and a lower portion 1099 of at least two flexible components configured in an INT-CORE configuration (as described in FIG. 6). In various embodiments, the INV-CORE configuration may include a mechanism with multiple traversal flexible components. In several embodiments, the INT-CORE configuration may include a mechanism with multiple half-traversal flexible components. In various embodiments, the flexible components of the upper portion 1098 may control the rotation about the Z-axis and the flexible components of the lower portion 1099 may control the rotation about the X-axis.

Both the upper portion 1098 and the lower portion 1099 may include at least two sets of flexible components to connect the rigid components and provide expansion in the y direction.

In various embodiments (and as shown in FIG. 11) the mechanism 1000 can comprise flexible components in the upper portion 1098 configured in an INV-CORE configuration and flexible components in the lower portion 1099 configured in an INT-CORE configuration. In the alternative, the mechanism 1000 can comprise the flexible components of the upper portion 1098 configured in an INT-CORE configuration and the flexible components of the lower portion 1099 configured in an INV-CORE configuration. In yet another alternative, the mechanism 1000 can be designed where the flexible components in both the upper portion 1098 and the lower portion 1099 are configured in the same configuration (INV-CORE or INT-CORE).

In various embodiments, the ICORE mechanisms 600, 700, 800, 900, and 1000 can be manufactured using any methods. In some embodiments, the ICORE mechanisms 600, 700, 800, 900, and 1000 can be manufactured using additive manufacturing. In a particular embodiment, the additive manufacturing can be 3D printing. In some embodiments, the ICORE mechanisms 600, 700, 800, 900, and 1000 can be manufactured as a single piece using additive manufacturing including, but not limited to 3D printing.

In various embodiments, the ICORE mechanisms 600, 700, 800, 900, and 1000 can be manufactured from any suitable material. In some embodiments, the ICORE mechanisms 600, 700, 800, 900, and 1000 can be manufactured from at least a metal including but not limited to titanium, alloy, titanium alloys, copper, aluminum, cobalt, zirconium, magnesium, chromium, stainless steel, steel, tantalum, mixtures thereof, or any other suitable metal or combinations of metals.

In some embodiments, the ICORE mechanisms 600, 700, 800, 900, and 1000 can be manufactured from at least a polymer including but not limited to polyethylene (PE), polypropylene, poly methyl methacrylate (PMMA), polyetheretherketone (PEEK), polysulfone, carbon fiber, glass fiber, polytetrafluoroethylene (PTFE), high density polyethylene (HDPE), ultra-high molecular weight polyethylene, silicone rubbers, teflon, polyacetal, polyacetal polyethylene, combinations thereof, or any other suitable polymer or combination of polymers. In some embodiments, the ICORE mechanisms 600, 700, 800, 900, and 1000 can be manufactured as at least a portion of a device. In other embodiments, the ICORE mechanisms 600, 700, 800, 900, and 1000 can be manufactured as a device. In additional embodiments, the ICORE mechanisms 600, 700, 800, 900, and 1000 can be manufactured as at least a portion of a device wherein the device is an industrial device, satellite device, medical device.

In various embodiments, the ICORE mechanisms 600, 700, 800, 900, 1000 can be manufactured as an implant. In additional embodiments, the mechanism 600, 700, 800, 900, and 1000 can be manufactured as an implant including but not limited to spinal implants.

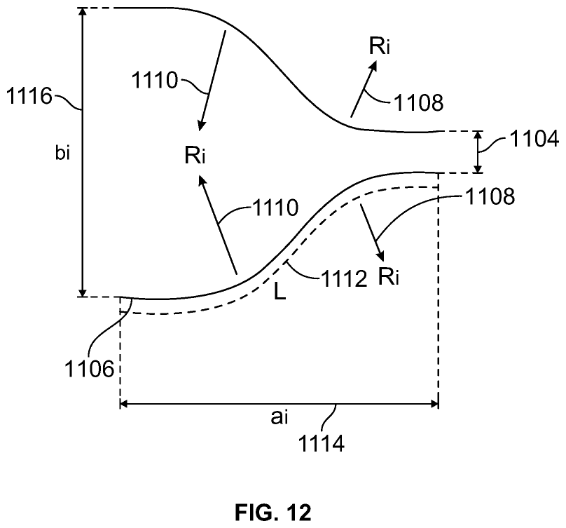

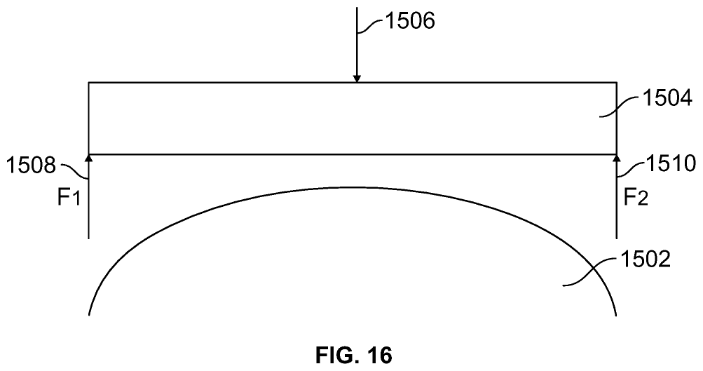

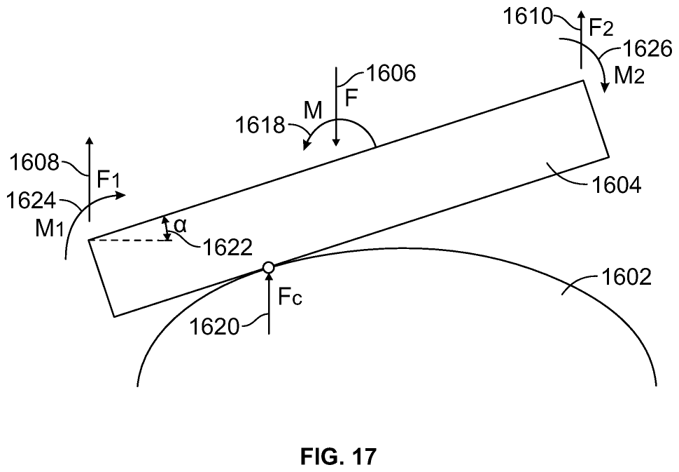

FIGS. 12-19 illustrate methods of analysis and mechanical properties of the various embodiments of the ICORE mechanisms 600, 700, 800, 900, 1000.

Various embodiments of the ICORE mechanism as described herein were analyzed using a pseudo-rigid-body replacement model (PRBM) of the I-CORE mechanism, which was subsequently validated using both finite element analysis (FEA) and bench top mechanical testing.

The PRBM for this mechanism draws upon principles of previously developed equations for a “fixed-guided” mechanism, an “initially curved” mechanism, and a combined force load and moment load mechanisms. The “fixed-guided” mechanism is one that is fixed at one end, while the other end can translate, but not rotate. The PRBM for this “fixed-guided” mechanism employs three rigid segments with two rotational springs in a similar manner to what is proposed for the ICORE mechanism. Unlike a fixed guided mechanism, the ICORE mechanism included some initial curvature in the flexible components that affected the mechanical properties. As a result, the principles previously developed for an initially curved beam were also integrated. While a force load is the most common and simplest to model in terms of compliant mechanisms, the ICORE mechanism is designed to rotate, and the mechanisms will therefore encounter moment loads which can be more difficult to model. To account for this, a method was implemented in which the curvature caused by the moment load is accounted for in the initial curvature calculation.

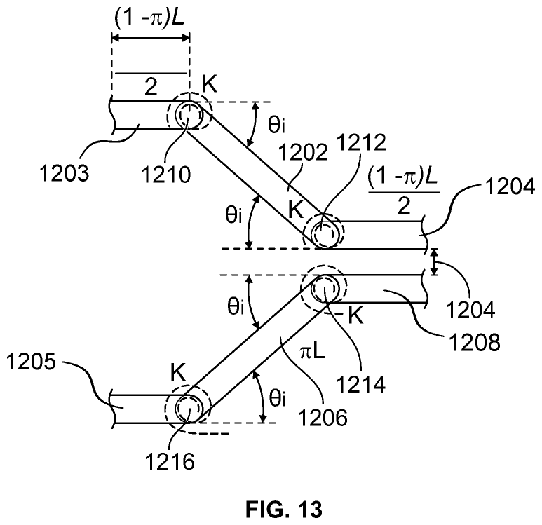

FIGS. 12-13 illustrate the pseudo rigid body model of the mechanism stack used in the ICORE mechanism. FIG. 12 illustrates a line drawing of the mechanisms which is converted into FIG. 13 which illustrates a system of rigid bodies (e.g., 1202, 1203, 1204, 1205, 1206, 1208) pin joints, and rotational springs (e.g., 1210, 1212, 1214, 1216).

The model for this mechanism developed using the PRBM (as shown in FIGS. 12 and 13) was divided into two parts: the first involved vertical compression prior to the bearing surfaces coming into contact, and the second involved the rotation of the top face of the ICORE mechanism relative to the lower portion after the bearing surfaces made contact. Before the bearing surfaces came into contact, the force vs displacement was completely determined by the stiffness of the compliant mechanisms.

Subsequently, the force vs. displacement profile evolved into a combination of the compliant mechanisms and the contacting rigid bodies with the material stiffness of the rigid bodies being the most significant factor.

The key to converting these compliant mechanisms into virtual rigid bodies with pin joints and torsional springs, was to determine the location of the pin joints and the torsional spring constants. For initially curved mechanisms 1106 that experience both force and moment end loading, the curvature of the mechanisms K0 first had to be determined. For an initially curved cantilever beam with no moment load the following equation can be used:

$$\\ {K}_{0} = \frac{L}{{R}_{i}}$$

where L is the arc length of the mechanism 1112 and Ri 1108, 1110 is the initial radius of the curved mechanism. In certain embodiments, Ri 1108, 1110 may be any desired radius without departing from the principles of this disclosure. Separately, for a beam with a moment load, the final radius caused by the moment load can be incorporated into the calculation of K0. In this case, the angle is known leading to the following equation:

$$\\ {K}_{0} = \frac{L}{2 ( {R}_{i} - \frac{L}{α} )}$$

where K0 represents the curvature, L is the arc length of each mechanism, Ri is the initial radius of curvature of each mechanism, and a is the angular displacement of the top plate of the mechanism.
As shown in FIG. 13, each mechanism was split into two shorter rigid members 1203, 1204, 1205, 1208 on either end with a longer rigid member 1202, 1206 in the center. An equation for the length of the two smaller members taken from a model for “fixed-guided” mechanism is used in this case as follows:

$$\\ \frac{( 1 - ρ ) L}{2}$$

Similarly, the length of the longer member was set forth as:

ρL

Where ρ is a tabulated value correlated with K0. With the locations of the pin joints known, the equation for the torsional spring constant was developed by combining the principles of a “fixed-guided” compliant beam with those of an “initially curved” compliant member described which resulted in the following:

$$\\ K = \frac{2 ρ {K}_{Θ} EI}{L}$$

KΘ symbolizes the stiffness coefficient. E is the modulus of elasticity of the material, and/is the moment of inertia of the mechanism cross section. With the PRBM for each stack of mechanisms fully defined, an equation for the vertical force generated by each mechanism stack was developed as:

$$\\ F = \frac{2 K ( {Θ}_{i} - {Θ}_{c} )}{ρ L}$$

$$\\ {Θ}_{i} = {sin}^{- 1} ( \frac{{b}_{i} - G}{2 ρ L} )$$

$$\\ {Θ}_{c} = {sin}^{- 1} ( \frac{{b}_{f} - G}{2 ρ L} )$$

where Θi is the initial angle as shown in FIG. 6 and Θc is the compressed angle, bi is the initial vertical height of the mechanism stack, and bf is the final height, and G is the gap between the mechanisms. The moment generated by each mechanism stack was approximated as:

$$\\ M = \frac{- K α}{4}$$

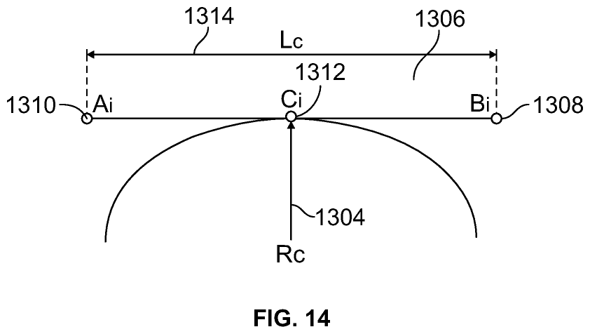

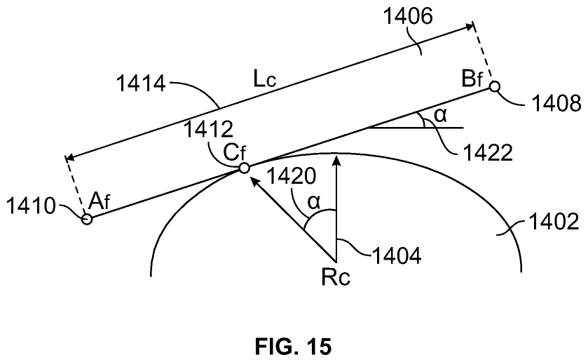

FIGS. 14 and 15 illustrate the moving center of rotation. FIG. 14 illustrates an initial position and FIG. 15 illustrates a final rotated position. FIGS. 14 and 15 are illustrated using subscript “i” to indicate initial and “f” to indicate final. “a” and “b” indicate ends of the plate (1310, 1410, 1308, and 1408 respectively). “c” 1304, 1412 indicates the center. FIGS. 14 and 15 are illustrated using “alpha” 1404 as the angle of the plate and Rc 1304, 1404 as the radius of the rounded contact surface. The ICORE mechanism advantageously may include a mobile center of rotation as the top part of the mechanism rolls along the rounded contact surface. An important assumption made in the development of the PRBM was that these two parts of the mechanism will not slide relative to one another. For simplicity, it was also assumed that a 1420 was initially equal to 0. The following equations were developed to account for the moving center of rotation.

$$\\ {A}_{f} {C}_{f} = {A}_{i} {C}_{i} - {R}_{c} α$$

where AiCi is the initial distance from A to C, and AfCf is the distance at some angle α. Similarly, the distance from point B to point C at the angle α is:

$$\\ {B}_{f} {C}_{f} = {L}_{c} - {A}_{f} {C}_{f}$$

Using the prior equations, the change in the vertical position of points A and B can be solved, which corresponds to the vertical positions of the mechanism stacks that were in the mechanism.

$$\\ Δ {A}_{y} = {A}_{iy} - {R}_{c} ( 1 - cos ( α ) ) - {A}_{f} {C}_{f} sin ( α )$$

$$\\ Δ {B}_{y} = {B}_{iy} - {R}_{c} ( 1 - cos ( α ) ) + {B}_{f} {C}_{f} sin ( α )$$

With the assumption that A was always moving in the negative y direction and B moving in the positive y direction. Using the prior equations, bf could be determined for with the relationships:

$$\\ {b}_{f 1} = {b}_{i} - Δ {A}_{y} and {b}_{f 2} = {b}_{i} + Δ {B}_{y}$$

where bf1 corresponded to the mechanism that contacted the rigid body at point A and bf2 represented the mechanism that contacted the rigid body at point B. The focus of the analysis was directed to calculations of a single mechanism stack, but the combination of the two mechanism stacks with the rolling contacts on either side is what renders the ICORE mechanism and device unique. Equations for the full mechanism were therefore determined. These were found by performing a simple static force equilibrium calculation on the rotating top plate of the mechanism as seen in FIG. 8. This resulted in the following equations:

$$\\ F = {F}_{1} + {F}_{2} + {F}_{c}$$

where F is the load on the mechanism, F1 is the force from mechanism 1, F2 Is the force from mechanism 2, and Fc is the force from the curved contact. Note that Fc is 0 until the upper and lower rigid bodies come into contact and it changes position with α. These two facts had a significant impact on the equation for the overall moment which is:

$$\\ M = ( {F}_{1} {A}_{f} {C}_{f} - {F}_{2} {B}_{f} {C}_{f} + F ( {B}_{f} {C}_{f} - \frac{{L}_{c}}{2} ) ) cos ( α ) + {M}_{1} + {M}_{2}$$

Where M is the applied moment to the device.

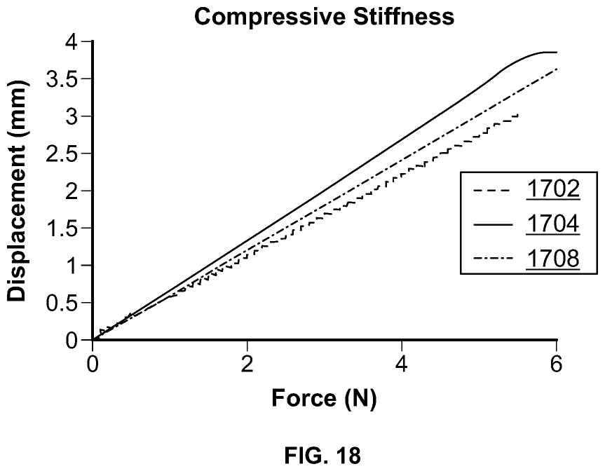

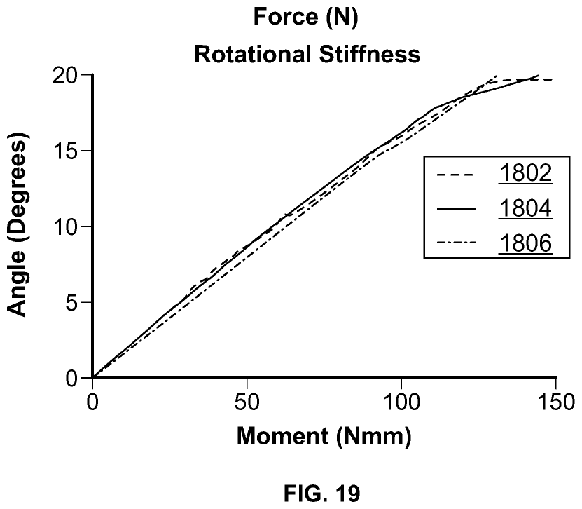

FIG. 18 illustrates example force displacement plots of benchtop 1702, FEA 1704, and PRBM 1708 data with compression. FIG. 19 illustrates example force displacement plots of benchtop 1802, FEA 1804, and PRBM 1806 data with rotation.

In both compression and rotation, the mechanism showed a linear curve. Compressive stiffness and rotational stiffness values were calculated compared to results from the benchtop testing. Though the true values were unknown, the agreement between benchtop testing 1702, 1802, FEA 1704, 1804, and the PRBM 1708, 1806 indicate the validity of the PRBM. The difference between each method was calculated using the following equations:

$$\\ \% Difference = \frac{\vert benchtop - FEA \vert}{benchtop} * 100$$

$$\\ \% Difference = \frac{\vert benchtop - PRBM \vert}{benchtop} * 100$$

$$\\ \% Difference = \frac{\vert FEA - PRBM \vert}{FEA} * 100$$

In terms of application of the mechanism, just as the previously developed CORE mechanism may be used for the development of a biomechanically improved disc replacement device, this ICORE device could also be used as a biomechanically enhanced intervertebral device. Total disc replacement (TDR) is a surgical procedure that involves the removal of a damaged or degenerated spinal disc and subsequent placement of a device that preserves some of the healthy disc motion. By preserving the motion of the affected spinal unit, the likelihood of developing adjacent segment disease or the rapid degeneration of discs immediately above and below the fused segment is reduced. In reducing the chances of further degeneration, the prospect of further spinal fusion is also decreased. Utilization of this procedure in the lumbar spine remains relatively low when compared to a procedure which completely immobilizes the spinal segment in question. One factor that likely contributes to this discrepancy is the lack of existing device solutions that match the biomechanics of a healthy spinal disc. The combination of vertical compressibility with a high compressible load bearing capability, 2 degrees of rotational freedom at a tailorable stiffness, a mobile center of rotation, and rolling friction to minimize wear debris all combine to make the ICORE mechanism an advantageous mechanism to be used in development of a total disc replacement device that could match the biomechanics of a healthy spinal disc.

Aside from the spine, the kinematics of this device resemble the kinematics seen in multiple different joints in the body including the knee, ankle, wrist, and elbow. Most joint replacements currently used for these procedures are friction-free ball and socket type mechanisms. The ability of the ICORE mechanism to rotate at some prescribed stiffness with a rolling motion to minimize wear debris has the potential to improve post-surgical biomechanics in these joints as well.

### CONCLUSION

The foregoing description of the exemplary embodiments has been presented only for the purposes of illustration and description is not intended to be exhaustive or to limit the devices, systems, methods, and apparatuses herein to the precise forms disclosed. Many modifications and variations are possible considering the above teachings.

The embodiments were chosen and described in order to explain the principles of the technology discussed herein and their practical application to enable others skilled in the art to utilize the various embodiments and with various modifications as are suited to the particular use contemplated. Alternative embodiments will become apparent to those skilled in the art to which the present technologies pertain without departing from their spirit and scope.

What is claimed is:

1. A contact-aided compliant mechanism comprising:
a first rigid component;
a second rigid component;
a first flexible component;
a second flexible component;
each of the first and second flexible components comprising a first end, a second end, and a third end; and
the first and second flexible components disposed between the first and second rigid components.

2. The contact-aided compliant mechanism of claim 1, wherein the first, second, and third flexible components comprise a substantially v-shape.

3. The contact-aided compliant mechanism of claim 1, wherein the first rigid component is positioned parallel to the second rigid component.

4. The contact-aided compliant mechanism of claim 1, wherein the first rigid component is movable in at least one degree of freedom with respect to the second rigid component.

5. The contact-aided compliant mechanism of claim 1, wherein the first rigid component further includes at least one first body contact, wherein the body contact extends from one side of the first rigid component toward the second rigid component, and wherein the at least one first body contact includes a first bearing surface.

6. The contact-aided compliant mechanism of claim 5, wherein the second rigid component further includes at least one second body contact, wherein the second body contact extends from one side of the second rigid component toward the first rigid component, and wherein the at least one second body contact includes a second bearing surface.

7. The contact-aided compliant mechanism of claim 6, wherein at least one of the first or second bearing surfaces comprises a rounded surface.

8. The contact-aided compliant mechanism of claim 1, wherein the first rigid component, second rigid component, first flexible component, and second flexible component are manufactured using 3D printing.

9. A contact-aided compliant mechanism comprising:
a first rigid component, the first rigid component including a first bearing surface;
a second rigid component, the second rigid component including an upper and lower bearing surface;
a third rigid component, the third rigid component including a third bearing surface;
a plurality of flexible components, each of the flexible components including a first end, a second end, and a third end, wherein the first end is attached to one of the first, second, or third rigid component and wherein the third end is attached to one of the first, second, or third rigid component;
the first bearing surface selectively engaging the upper bearing surface; and
the third bearing surface selectively engaging the lower bearing surface.

10. The contact-aided compliant mechanism of claim 9, wherein at least one of the first, upper, lower, or third bearing surfaces has a rounded contour.

11. The contact-aided compliant mechanism of claim 9, wherein the first rigid component further includes at least one first body contact, wherein the body contact extends from one side of the first rigid component toward the second rigid component, and wherein the at least one first body contact includes the first bearing surface.

12. The contact-aided compliant mechanism of claim 9, wherein the second rigid component further includes at least two second body contacts, wherein a first second body contact extends from one side of the second rigid component toward the first rigid component, a second body contact extends from one side of the second rigid component toward the third rigid component, and wherein the first second body contact includes the upper bearing surface and the second body contact includes the lower bearing surface.

13. The contact-aided compliant mechanism of claim 9, wherein the third rigid component further includes at least one third body contact, wherein the third body contact extends from one side of the third rigid component toward the second rigid component, and wherein the at least one third body contact includes the third bearing surface.

14. The contact aided compliant mechanism of claim 9, wherein each of the flexible components further includes a first region disposed between the first end and the second end and a second region disposed between the second end and the third end.

15. The contact-aided compliant mechanism of claim 14, wherein the first region includes a first radius of curvature.

16. The contact-aided compliant mechanism of claim 14, wherein the second region includes a second radius of curvature.

17. The contact-aided compliant mechanism of claim 9, wherein each of the first and second regions comprise a Euler spiral.
